(19) United States
(12) Patent Application Publication
(10) Pub. No.: US 2007/0134612 A1
(43) Pub. Date: Jun. 14, 2007

(54) DENTO-FACIAL ORTHOPEDIC TREATMENT AND ORTHODONTIC ARCH WIRE FOR IMPLEMENTING THE SAME

(76) Inventor: Bernard Contencin, Remire-Monjoly (FR)

Correspondence Address: GRIFFIN & SZIPL, PC, SUITE PH-1, 2300 NINTH STREET, SOUTH, ARLINGTON, VA, 22204, US

(21) Appl. No.: 11/276,733

(22) Filed: Mar. 13, 2006

(30) Foreign Application Priority Data
Dec. 9, 2005 (EP) 05292632.6

(51) Int. Cl. A61C 3/00

(52) U.S. Cl. 433/24; 433/20

(57) ABSTRACT

The invention concerns an orthodontic treatment using brackets bonded via their base onto each tooth of a dental arch, each bracket having a slot into which a first orthodontic arch wire is introduced so as to cause to move, the first orthodontic arch wire being held in slots of the brackets by ligatures, wherein the first orthodontic arch wire that remains in the mouth is introduced into the slots of the brackets; after the first orthodontic arch wire, a second orthodontic arch wire is placed on top; the ligatures are tightened so as to shape the ligatures and press the two arch wires against the bottom of the slots in the brackets, and once the ligatures have been tightened and shaped, the second provisional orthodontic arch wire is removed so as to obtain loose ligatures having a constant play with the first orthodontic arch wire.

This application claims priority from European Patent Application No. 05292632.6, filed Dec. 9, 2005.

### FIELD OF THE INVENTION

The present invention concerns a dento-facial orthopedic treatment using brackets bonded via their base onto each of the teeth whose position one wishes to correct. These brackets each have a slot into which an orthodontic arch wire, called a therapeutic arch wire, is introduced.

### BACKGROUND OF THE INVENTION

Dento-facial orthopedics is the branch of dental surgery, which treats poorly positioned teeth and the associated corrective therapy. It thus consists in moving teeth while checking their position by means of a mechanical system which comprises, on the one hand, parts or brackets glued to the teeth whose position one wishes to correct, and, on the other hand, an element that is independent of the tooth, formed by a metal wire commonly called an orthodontic arch wire which is housed in the slot provided in the brackets bonded to the teeth.

At least three orthodontic bracket systems are known.

The first of these systems includes conventional brackets called active brackets which receive the orthodontic arch wire. The latter is held by means of metal or elastomeric ligatures. This system, known for example from EP Patent No. 0 379 668, has several drawbacks. The immobilisation force exerted by a metal ligature on a round orthodontic arch wire with a diameter of 0.5 mm is of the order of 125 g/cm². With an elastomeric ligature, this force is still 50 to 100 g/cm². Biological studies have shown that the force to be applied on a tooth whose position one wishes to correct should not exceed 20 to 25 g/cm². The immobilisation forces resulting from ligation by means of a metal or elastomeric wire thus exceed periodontal biological limits and lead to compression of periodontal capillaries, preventing blood flow in the capillaries. Moreover, it is very difficult with this technique to carry out treatment without dental extractions in the event of space requirements of more than 6 mm.

Other bracket systems called self-ligating have been proposed to overcome these problems of space requirement. These systems can be sorted into two categories. The first category includes passive self-ligating systems which allow the orthodontic arch wire a variable play in the bracket until said arch wire reaches the maximum dimension devised by the designer. The Ormco Company for example uses this bracket system. The second category includes interactive bracket systems which behave like passive brackets as regards the orthodontic arch wires of small dimensions and which behave like active brackets when the dimensions of the arch wires increase. This system is known for example from DE Patent No. 44 07100 in the name of Wolfgang Heiser exploited by the American Orthodontics Company.

These self-ligating brackets have certain drawbacks. First of all, they have an increased thickness resulting from the necessity of providing a mechanical system to replace the ligatures, hence an increased risk of the brackets becoming unstuck during chewing because of the larger moment arm. Moreover, these brackets are usually metal, which is unattractive. There exist brackets made of synthetic resin, but these tend to wear out prematurely because of their poor mechanical qualities. Furthermore, these resin brackets tend to absorb food dyes and quickly become unsightly. It should also be noted that as the section of the orthodontic arch wires to be fitted progressively increases, the arch wires become more and more difficult to set in place in the brackets because of their increased rigidity which makes it more difficult to close the locking system due to the decrease in the play of the arch wires in the brackets. It should be noted finally that because of corrosion of the resilient metal parts by saliva in the oral cavity, the mechanical features of the bracket closing systems are altered and can degenerate by oxidisation over time.

It is an object of the present invention to overcome the aforementioned drawbacks in addition to others by providing a dento-facial orthopedic treatment for considerably reducing the immobilisation force exerted on an orthopedic arch wire and for returning it to very low biologically acceptable values, close to zero.

### SUMMARY OF THE INVENTION

The present invention therefore concerns a dento-facial orthopedic treatment using brackets bonded via their base onto each of the teeth whose position one wishes to correct, these brackets each having a slot into which a therapeutic orthodontic arch wire is introduced so as to cause the teeth to move such that, at the end of the treatment, after removing the therapeutic orthodontic arch wire, the teeth are in the desired position, the therapeutic orthodontic arch wire being held in the slots of the brackets by means of ligatures, characterized in that:

a first therapeutic orthodontic arch wire that has to remain in the mouth is introduced into the slots of the brackets;

after the first therapeutic orthodontic arch wire, a second therapeutic orthodontic arch wire is placed on top;

the ligatures are tightened so as to shape the ligatures and press the two orthodontic arch wires against the bottom of the slots in the brackets, and

once the ligatures have been tightened and shaped, the provisional orthodontic arch wire is removed so as to obtain loose ligatures with a constant play with the first orthodontic arch wire.

Owing to these features, the present invention provides a dento-facial orthopedic treatment wherein the therapeutic orthodontic arch wire is held by means of loose ligatures thus reducing the immobilisation forces exerted on the arch wire and returning them to very low, almost zero, values, well below the biologically acceptable threshold. These loose ligatures have a constant and determined play in relation to the therapeutic orthodontic arch wire owing to the use of a temporary orthodontic over-arch wire which returns the forces exerted by the ligatures to extremely low values by removing the locking and slotting forces of conventional ligatures. The present invention applies to all types of bracket and particularly to ceramic brackets, which can considerably improve the aesthetic appearance of a bracket system. The conventional brackets used within the scope of the invention are made passive because of the existence of play between the therapeutic orthodontic arch wire and the ligatures for the entire duration of the treatment, independently of the progression of the dimension of the arch wire. It will also be noted that the insertion of the therapeutic orthodontic arch wire in the bracket slots is as easy as in conventional techniques for arch wires of larger dimensions.

According to another aspect, the present invention concerns an orthodontic arch wire characterized in that it includes at least two strands secured to each other at one place on their length.

The orthodontic arch wire concerned here is the provisional arch wire which, in accordance with the treatment of the invention, is to be placed on top on the therapeutic orthodontic arch wire and which is removed after the ligatures have been tightened by twisting. The advantage of this arch wire lies in the fact that, although similar to a single arch wire of rectangular cross section, the two or possibly more strands of which it is formed have an identical resistance force to bending in all directions in space in the case of bending along a direction perpendicular to the small edge of the arch wire, and lower than that of an orthodontic arch wire formed of a single strand of the same rectangular cross section. The provisional arch wire according to the invention is thus easier to deform and set in place clinically and to remove after ligation.

According to yet another aspect, the present invention concerns a bracket for a therapeutic orthodontic arch wire used in the field of dento-facial orthopedics, the bracket including a base via which it is bonded to the tooth whose position one wishes to correct, and a support which extends from the base and in which there is provided a slot for receiving the therapeutic orthodontic arch wire, this support being extended by a pair of hooks or wings which extend on either side of the slot and which delimit with the support a curvilinear groove parallel to the slot for receiving a ligature for holding the therapeutic orthodontic arch wire, characterized in that the grooves are deeper in the end zones of the wings.

The grooves are designed and manufactured to be deeper in the outer corners of the wings so as to ensure that the ligatures which have a calculated play with the therapeutic orthodontic arch wire after the provisional orthodontic arch wire has been removed cannot become detached from the brackets.

### BRIEF DESCRIPTION OF THE DRAWINGS

Other features and advantages of the present invention will appear more clearly from the following detailed description of an implementation of the treatment according to the invention, this example being given purely by way of non-limiting illustration, with reference to the annexed drawing, in which:

FIG. 1 is a perspective view of a dental arch fitted with brackets and with a therapeutic orthodontic arch wire;

FIG. 2 is a perspective view of one tooth of the dental arch of FIG. 1 fitted with a bracket into which the therapeutic orthodontic arch wire and the provisional orthodontic arch wire according to the invention have been introduced, with the ligature of the bracket about to be twisted;

FIG. 3 is a similar view to that of FIG. 2, the ligature of the bracket having been tightened so as to press the two orthodontic arch wires against the bottom of the bracket slot;

FIG. 4 is a similar view to that of FIG. 3 in which the provisional orthodontic arch wire has been partially removed;

FIG. 5 is a similar view to that of FIG. 4 in which the provisional orthodontic arch wire has been completely removed, leaving a play between the ligature and the therapeutic orthodontic arch wire that has to remain in the mouth;

FIGS. 6A, 6B and 6C are respectively perspective views of a provisional orthodontic arch wire according to the invention and of a plate for holding the arch wire;

FIGS. 7A to 7C are transverse cross-sections of strands of a provisional orthodontic arch wire according to the invention respectively having a circular cross section, a square cross section with rounded edges and formed of several strands;

FIG. 8 is a partial perspective view of an upper right dental arch showing in particular the end bracket into which the therapeutic orthodontic arch wire that remains in the mouth passes, and the part holding the provisional arch wire according to the invention;

FIG. 9 shows the temporary immobilisation of the provisional arch wire at the central incisor of the top left dental arch;

FIG. 10 shows in perspective the first ligature made on the first premolar;

FIG. 11 shows in perspective the second ligature made on the second premolar, the holding plate having been removed;

FIG. 12 shows in perspective the canine ligature step;

FIG. 13 shows in perspective the top right dental arch completely ligated as far as the centre right incisor;

FIG. 14 is a schematic top view of a dental arch along which two provisional orthodontic semi-arch wires are placed,

FIG. 15A is a perspective view of a ceramic bracket in which hollows have been made that open out into the lateral face of the hooks;

FIG. 15B is a similar view to that of FIG. 15A, the therapeutic orthodontic arch wire and the provisional orthodontic arch wire being held in place by a ligature;

FIG. 15C is a top view of the bracket illustrated in FIG. 15B;

FIGS. 16A to 16C are similar views to those of FIGS. 15A to 15C respectively, the bracket being a bracket made of a resistant material, for example metal, in which deeper hollows are made which open out into the side and front face of the hooks, and

FIG. 16D is a side view of the bracket illustrated in FIG. 15B.

### DETAILED DESCRIPTION OF THE INVENTION

The present invention proceeds from the general inventive idea which consists in providing a treatment and a device for the passive use of a conventional bracket system for receiving a therapeutic orthodontic arch wire for medical purposes that has to stay in the mouth. For this purpose, a first therapeutic orthodontic arch wire for conventional medical purposes is introduced into the slots of the brackets for correcting the orientation of the teeth, then a second provisional arch wire on top on the first arch wire, after which the ligatures of brackets are tightened to shape them and to press the arch wires into the bottom of the bracket slot. Once the ligatures have been tightened, the provisional arch wire is removed so that a play exists between the ligatures and the therapeutic arch wire that stays in the mouth. The friction forces due to locking the therapeutic orthodontic arch wire by the ligature when the ligature is shaped by tightening and twisting it on the bracket, are thus removed. The ligature not longer exerts any friction force by locking, but only by conventional friction as is described in the articles by Kusy R P entitled “Ongoing innovations in biomechanics and materials for the new millennium” published in Angle Orthod 2000 (70 366-376) and by Thorstenson G. entitled “Etude sur la friction des brackets SmartClip™ auto-ligaturants” published in Orthodontics Perspectives Volume XII no. 1.

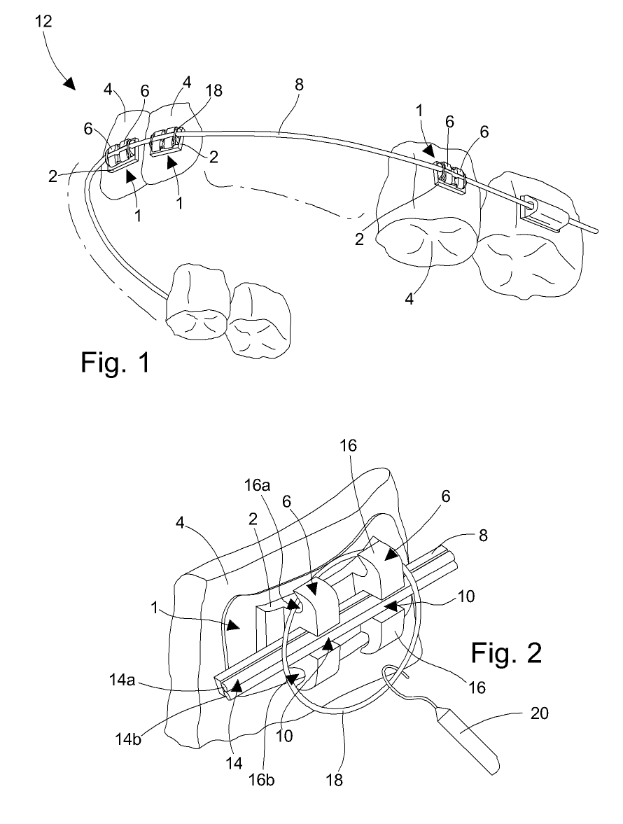

As can be seen in FIGS. 1 and 2, the dento-facial orthodontic treatment according to the invention uses brackets 1 bonded via their bases 2 onto the vestibular face of poorly positioned teeth 4, whose position one wishes to change by moving the teeth. These brackets 1 also include, on the free face of their bases 2, a pair of supports 6 for a therapeutic orthodontic arch wire 8 (see FIG. 2). These supports 6 are arranged parallel to and at a distance from each other along a transverse direction to the longitudinal direction of the therapeutic orthodontic arch wire 8. They each include a slot 10 that is open on the side of the patient's lip and aligned with slot 10 of the opposite support 6, such that arch wire 8 can pass into slots 10 matching the contour of dental arch 12.

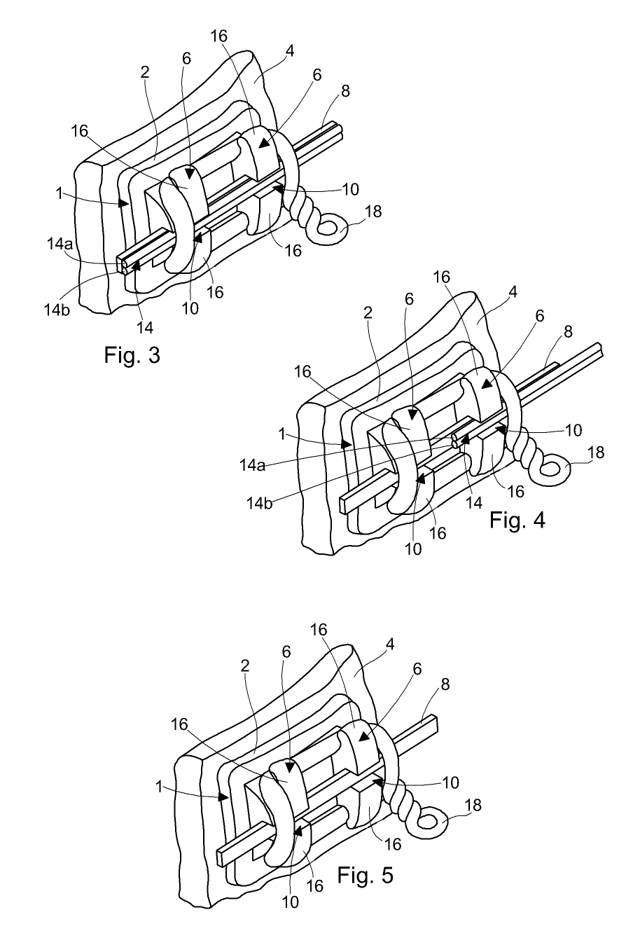

As can be seen in FIG. 2, a second orthodontic arch wire 14 is placed on top of the first therapeutic orthodontic arch wire 8. As described in detail hereinafter, the second arch wire 14 is a provisional arch wire which will be removed after arch wire 8, which stays in the mouth, has been set in place. Thus, each support 6 is extended at its ends by a hook or wing 16, these hooks 16 delimiting an upper groove 16a and a lower groove 16b for fixing a ligature 18 for pressing orthodontic arch wires 8 and 14 against the bottom of slots 10 of supports 6. Ligatures 18 are passed into the upper and lower grooves 16a and 16b and above arch wires 8 and 14 before being tightened, for example by twisting using a suitable tool 20 (see FIGS. 2 and 3). These ligatures 18 are metallic but could be elastomeric.

After ligatures 18 have been tightened (see FIG. 3), provisional orthodontic arch wire 14 is removed, so that a play remains between the ligatures 18 and therapeutic orthodontic arch wire 8 that has to stay in the mouth (see FIGS. 4 and 5). The holding force from a tightened ligature that is exerted on therapeutic orthodontic arch wire 8 is thus considerably minimised returning it to more than biologically acceptable residual values of the order of 0.2 to 0.5 mg/cm². Compared to conventional ligatures, the friction forces between the ligatures and the orthodontic arch wire are thus reduced by a factor comprised between 250 and 600 insofar as the locking friction forces are removed.

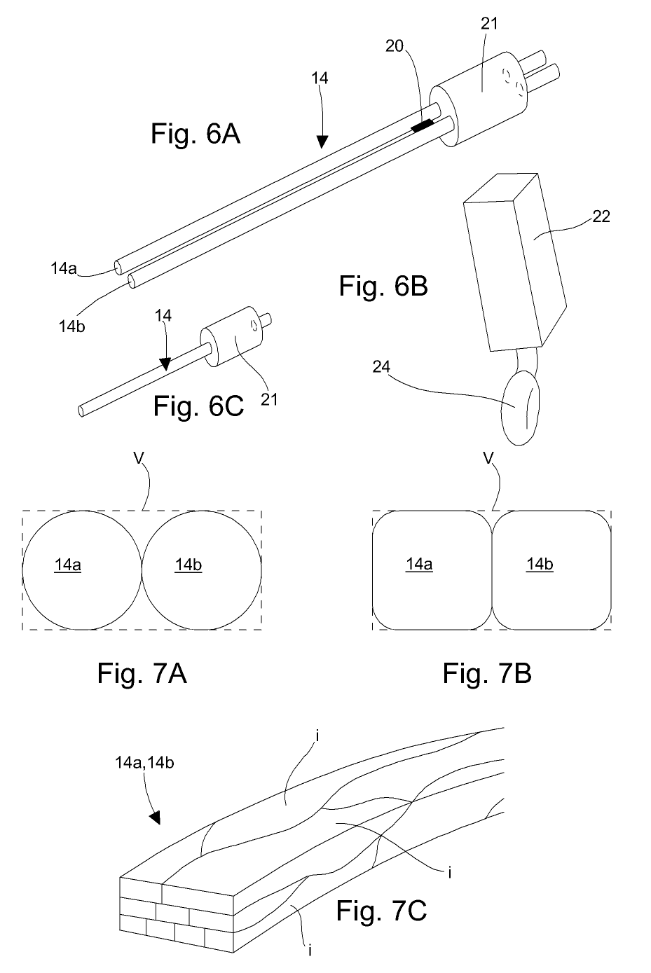

According to the invention and as shown in FIG. 6A, provisional orthodontic arch wire 14 is formed of at least two strands 14a and 14b secured to each other at one point on their length, for example by means of a weld spot 20. The two strands 14a and 14b have substantially the same length and are preferably but not restrictively secured to each other at one of their ends. The main advantage of this orthodontic arch wire 14 is that the two strands 14a and 14 of which it is formed have a bending resistance along the direction perpendicular to the small edge of the arch wire lower than an orthodontic arch wire formed of a single strand of the same rectangular section. Provisional arch wire 14 according to the invention is thus easier to deform and set in place and to remove after ligation. It will be noted that certain clinical situations require the use of therapeutic orthodontic arch wires with a very small section. In these cases, provisional orthodontic arch wire 14 could be reduced to a single strand, by cutting the other strand flush with crimp 21 (see FIG. 6C).

As can be seen upon examining FIGS. 7A and 7B, the two strands 14a and 14b are within an envelope V whose cross section is comparable to a rectangle and whose dimensions are such that they allow arch wire 14 to be housed in the profile of slots 10. The two strands 14a and 14b can be of circular or square cross section with rounded edges. They can also be of rectangular cross section, composed of several strands i as illustrated in FIG. 7C, strands i being plaited and then laminated. More generally, these strands 14a and 14b can be made of any type of material depending upon the possibilities offered by changes in techniques, provided that they can be bent at the same angle in all directions in space.

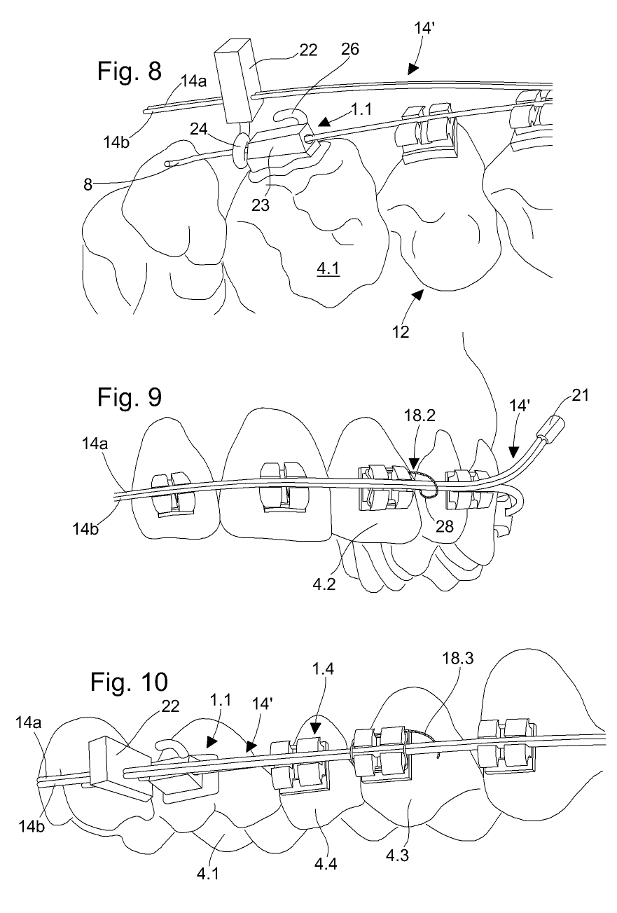

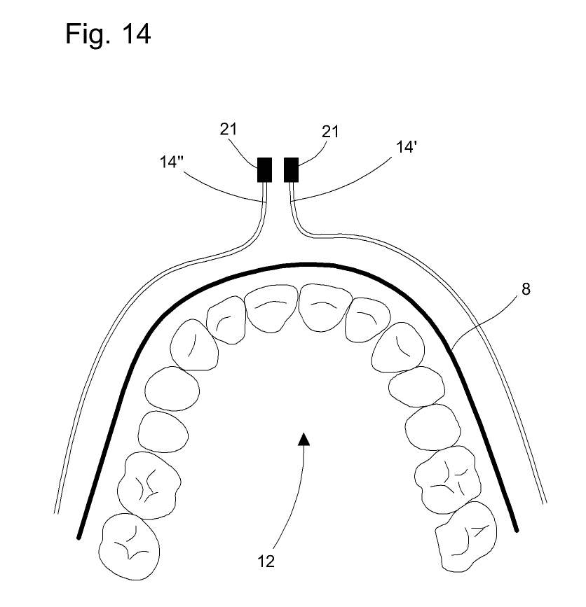

The method of setting provisional arch wire 14 in place will now be described with reference to FIG. 8 and the following Figures. A provisional arch wire 14 whose length corresponds to that of the complete dental arch 12 could be fitted. This would, however, be time consuming and inconvenient. This is why it is preferable to insert the therapeutic orthodontic arch wire first of all then first and second provisional arch wires 14′ and 14″ whose lengths are such that their opposite ends, secured by a crimp 21, substantially meeting in the middle of dental arch 12 (see FIG. 14). We will now examine the setting in place of one of these two provisional arch wires 14′, 14″, along the right half of top dental arch 12, given that these operations are carried out symmetrically for the other half of the dental arch.

As can be seen upon examining FIG. 8, the back end of therapeutic orthodontic arch wire 8 that has to stay in the mouth is inserted in the tube 23 of an end bracket 1.1 in order to be secured thereto. Provisional arch wire 14′ is jabbed into a holding and positioning plate 22 (see FIG. 6A) which it pierces and which is extended by a ring 24, which one can, if desired, thread onto hook 26 of the end bracket 1.1 bonded onto molar 4.1 if the latter has one or onto the back end of the therapeutic orthodontic arch wire 8 hanging out of tube 23. It can also be secured to the bracket that is furthest back if clinical conditions so require. Holding plate 22 is advantageously made of a resilient material such as an elastomer, urethane or other material. When therapeutic arch wire 8 is of small size, for example 0.014 inches the over-arch wire can be inserted into tube 23 again for the purpose of positioning it subsequently (FIG. 8). The weld spot will then be located at this end, and the wire will receive a plastic sheath over approximately half of its length. The front end of the orthodontic arch wire 14′ is held in place by a provisional ligature 18.2 made on the central incisor 4.2 of the left half of the top dental arch 12 which will be treated in a subsequent step of the procedure (see FIG. 9). In order to facilitate the hold of orthodontic arch wire 14′, FIG. 9 shows that the twist resulting from the tightening of provisional ligature 18.2 is bent into a hook 28. It will also be noted that, at the back end of the orthodontic arch wire 14′, there is a bulge or setting 21 that can be secured to arch wire 14′ for example by crimping and which is for facilitating handling of arch wire 14′ using conventional dentistry tools.

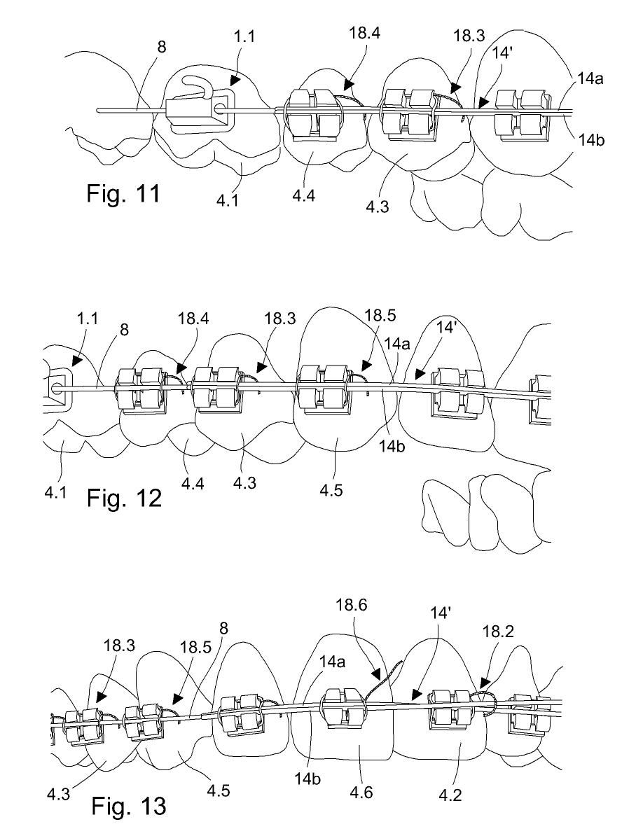

At the start of positioning, provisional orthodontic arch wire 14′ is thus held at its back end by holding plate 22 and is passed under the bent twisted hook 28 at its front end. Ligatures 18.3 of the first premolar 4.3 is then tightened leaving bracket 1.4 of the second premolar 4.4 free (see FIG. 10). After holding plate 22 has been removed, traction is exerted on orthodontic arch wire 14′ in order to slide it and bring its back end between brackets 1.1 and 1.4 of molar 4.1 and the second premolar 4.4 Ligature 18.4 of this second premolar 4.4 can then be tightened (see FIG. 11).Next, arch wire 14′ is pulled again in order to slide it band bring it between the two premolars 4.3 and 4.4. Ligature 18.5 of the canine 4.5 that immediately follows the first and second premolars 4.3 and 4.4 (see FIG. 12) is then tightened. The operation is repeated until central incisor 4.6 of the right half of the top dental arch is reached as shown in FIG. 13. It will be observed that by doing so, provisional orthodontic arch wire 14′ according to the invention is not held by more than two ligatures at any given moment during its insertion, which facilitates the progressive movement thereof while reducing to a minimum the friction forces between the ligatures and the arch wire. When the process has finished and the provisional arch wire has been completely removed, the ligatures present have been tightened and thus shaped on the brackets but between them and the therapeutic orthodontic arch wire that will stay in place, there exists a constant play for each bracket which reduces the holding forces exerted on the arch wire to very low biologically acceptable values. The same process is followed to insert the other provisional arch wire 14″ on the left half of top dental arch. First of all provisional ligature 18.2 made on left incisor 4.2 is taken off and the twist of ligature 18.6 made on right incisor 4.6 is bent into a hook. Once provisional arch wire 14″ is held at its front and back ends, the succession of operations described hereinbefore with reference to the right half of the top dental arch is repeated on the left half of the top dental arch.

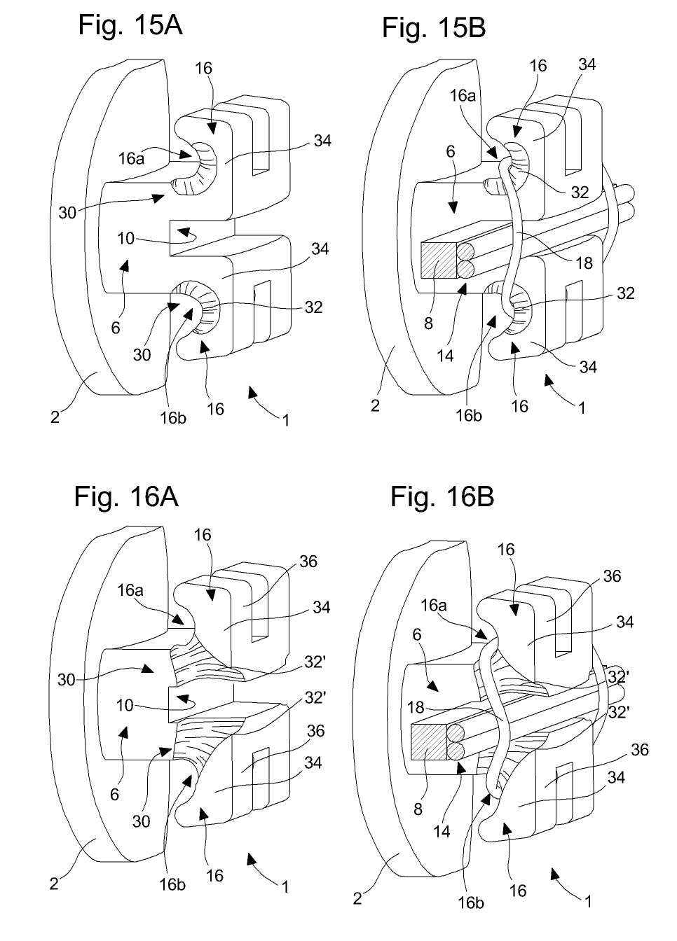

A particular embodiment of a bracket 1 made of a fragile material such as a ceramic material or resin will now be examined with reference to FIGS. 15A to 15C. As already described hereinbefore, this bracket 1 for therapeutic orthodontic arch wire 8 used in the field of dento-facial orthopedics includes a base 2 via which it is bonded onto the tooth whose position one wishes to correct. The bracket 1 also includes a support 6 which extends from base 2 and in which a slot 10 is provided for receiving therapeutic orthodontic arch wire 8. Moreover, support 6 is extended by two pairs of hooks 16 which extend on either side of slot 10 and which delimit with the support 6 two respectively top and bottom grooves 16a and 16b parallel to the slot 10. Of course, according to a variant, the bracket may include only a single pair of hooks arranged on either side of the slot and extending all along the slot.

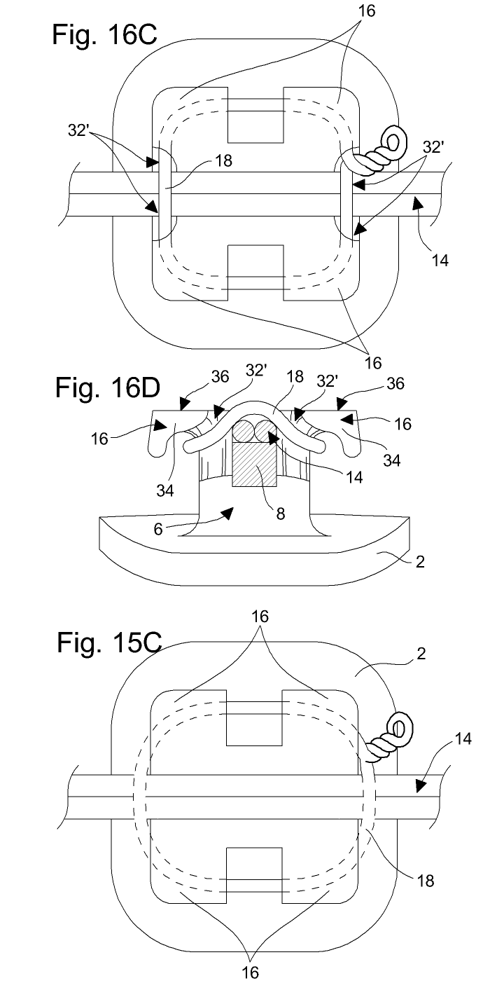

Grooves 16a, 16b are for receiving ligature 18 which will hold therapeutic orthodontic arch wire 8 with a very low biologically acceptable force. As can be seen upon examining FIG. 15A, grooves 16a and 16b are deeper in their end zones 30 than over the rest of their length. More specifically, these end zones 30 are shaped in hollows 32 which open out into the lateral face 34 of hooks 16. The effect of these hollows 32 is to move ligature 18 away from the end of wings 16, which prevents the ligature 18 from being released once it has been ligated by twisting on therapeutic orthodontic arch wire 8 and provisional orthodontic arch wire 14 has been removed. As already mentioned hereinbefore, the bracket 1 shown in FIGS. 15A to 15C is really provided for ceramic or resin type materials with poor mechanical qualities whose mechanical resistance is not as great as that of a metal bracket. This is why the hollow only opens into lateral face 34 of hooks 16 to avoid weakening too much the connecting zone between support 6 and the hooks 16. However, in the case of the bracket 1 shown with reference to FIGS. 16A to 16D, the latter is made of metal. Its mechanical resistance is thus greater than that of a ceramic bracket, which means that hollows 32′ can open out into lateral face 34 and into front face 3 of hooks 16. Ligature 18 is thus further removed from the end of hooks 16 without the joining zone between the hooks 16 and support 6 being weakened to the point that it is liable to break.

It goes without saying that the present invention is not limited to the implementation that has just been described and that various simple alterations and variants can be envisaged by those skilled in the art without departing from the scope of the invention defined by the annexed claims. In particular, the depth of the hollows made at the ends of the grooves will be adapted depending upon the maximum distance that can be observed between the therapeutic orthodontic arch wire and the ligature after the provisional orthodontic arch wire according to the invention has been removed.

1. A dento-facial orthodontic treatment using brackets bonded via bases onto each of the teeth of a dental arch whose position is to be corrected, wherein each bracket has a slot into which a therapeutic orthodontic arch wire is introduced so as to cause teeth to move, such that at an end of treatment, after the therapeutic orthodontic arch wire has been removed, teeth of the dental arch are in a desired position, wherein during treatment the therapeutic orthodontic arch wire is held in slots of the brackets by ligatures, wherein the dento-facial orthodontic treatment comprises the steps of:
(a) introducing a first therapeutic orthodontic arch wire, that has to remain during treatment in the mouth, into slots of the brackets;
(b) after the first therapeutic orthodontic arch wire is introduced, placing a second orthodontic arch wire on top of the first therapeutic orthodontic arch wire;
(c) tightening the ligatures so as to shape the ligatures and press the first orthodontic arch wire and the second orthodontic arch wire against a bottom of the slots in the brackets; and
(d) once the ligatures have been tightened and shaped, removing the second orthodontic arch wire so as to obtain loose ligatures having a constant play with the first orthodontic arch wire.

2. A treatment according to claim 1, wherein once the first therapeutic orthodontic arch wire has been set in place and, the second orthodontic arch wire is placed on top of the first orthodontic arch wire, the treatment further comprises the steps of:
tightening a first ligature of a first tooth;
then tightening a second ligature of a second tooth located between the first tooth and a third tooth that carries an end bracket for guiding the first therapeutic arch wire; and
then moving a first provisional orthodontic arch wire of the second orthodontic arch wire so as to bring a free end thereof between the first tooth and the second tooth and ligating a fourth tooth that immediately follows the first tooth that has been ligated.

3. A treatment according to claim 1, wherein the second orthodontic arch wire comprises a first provisional orthodontic semi-arch wire and a second provisional orthodontic semi-arch wire, and once the first therapeutic orthodontic arch wire has been set in place, the first provisional orthodontic semi-arch wire then the second provisional orthodontic semi-arch wire are placed on top of the first orthodontic arch wire so that opposite free ends of the first provisional semi-arch wire and the second provisional semi-arch wire meet substantially at center of the dental arch.

4. Orthodontic arch wire comprising at least two strands secured to each other at one place on a length of each strand.

5. Orthodontic arch wire according to claim 4, wherein the at least two strands are of identical lengths and free ends thereof are aligned.

6. Orthodontic arch wire according to claim 4, wherein the at least two strands are secured to each other at one end of the strands.

7. Orthodontic arch wire according to claim 4, wherein the at least two strands are shaped so as to be inscribed in an envelope whose cross section is substantially rectangular.

8. Orthodontic arch wire according to claim 7, wherein the at least two strands are round or have rounded edges.

9. Orthodontic arch wire according to claim 8, wherein a cross section of each strand is circular, square or rectangular.

10. Orthodontic arch wire according to claim 4, further including, at a free end, a bulge for facilitating gripping thereof.

11. An assembly for attaching to a dental arch an orthodontic arch wire comprising at least two strands secured to each other at one place on a length of each strand, wherein the assembly includes;
a plate for holding the arch wire, wherein the plate is extended by a ring that is passed either over a hook of a tube of a molar ring, or over a free end of a main arch wire of the orthodontic arch wire, or over a given bracket.

12. An assembly according to claim 11, wherein the assembly is made of a flexible material.

13. An assembly according to claim 12, wherein the flexible material is an elastomer including urethane.

14. An assembly including:
at least two brackets for orthodontic use bonded via bases onto teeth whose position is to be corrected each bracket having a slot into which a therapeutic orthodontic arch wire is inserted in order to cause teeth to move, such that at an end of treatment, after the therapeutic orthodontic arch wire has been removed, the teeth are in a desired position, wherein during treatment the therapeutic orthodontic arch wire is held in the slots by tightened ligatures, wherein play between the ligatures and the therapeutic orthodontic arch wire is the same between the at least two brackets.

15. A bracket for therapeutic orthodontic arch wire used in the dento-facial orthopedics field, the bracket including:
a base via which the bracket is bonded onto a tooth whose position is to be corrected; and
a support that extends from the base and in which a slot is provided for receiving therapeutic orthodontic arch wire, wherein the support is extended by a pair of wings that extend on either side of the slot, wherein the pair of wings, with the support, delimit grooves parallel to the slot for receiving a ligature for holding therapeutic orthodontic arch wire, wherein the grooves are deeper in end angular zones of the wings than over the rest of the length of the grooves so as to form a curvilinear path.

16. A bracket for therapeutic orthodontic arch wire according to claim 15, wherein the end zones are shaped in hollows that open out into a lateral face of the wings.

17. A bracket for therapeutic orthodontic arch wire according to claim 15, wherein the end zones are shaped in hollows that open out into a lateral face and into a front face of the wings.

18. A bracket for therapeutic orthodontic arch wire according to claim 16, wherein the bracket is made of a ceramic or synthetic material.

19. A bracket for therapeutic orthodontic arch wire according to claim 17, wherein the bracket is made of a metallic material.

20. Orthodontic arch wire including a bulge at one end.

21. A treatment according to claim 2, wherein the second orthodontic arch wire comprises a first provisional orthodontic semi-arch wire and a second provisional orthodontic semi-arch wire, and once the first therapeutic orthodontic arch wire has been set in place, the first provisional orthodontic semi-arch wire then the second provisional orthodontic semi-arch wire are placed on top of the first orthodontic arch wire so that opposite free ends of the first provisional semi-arch wire and the second provisional semi-arch wire meet substantially at a center of the dental arch.

22. Orthodontic arch wire according to claim 5, wherein the at least two strands are secured to each other at one end of the strands.
